(19) United States
(12) Patent Application Publication
(10) Pub. No.: US 2014/0237533 A1
(43) Pub. Date: Aug. 21, 2014

(54) METHOD AND SYSTEM FOR MANAGING INTERACTIVE MULTIMEDIA CONTENT BROADCAST ON TELEVISION

(71) Applicants: Gilbert Cabasse, Brest (FR); Fabrice Bonnaud, Brest (FR)

(72) Inventors: Gilbert Cabasse, Brest (FR); Fabrice Bonnaud, Brest (FR)

(73) Assignee: Alcatel Lucent, Paris (FR)

(21) Appl. No.: 14/000,010

(22) PCT Filed: Feb. 16, 2012
(86) PCT No.: PCT/EP12/52650

§ 371 Date: Nov. 25, 2013

(30) Foreign Application Priority Data
Feb. 18, 2011 (EP) 11290097.2

(51) Int. Cl. H04N 21/235; H04N 21/258; H04N 21/231

(52) U.S. Cl. CPC H04N 21/2353; H04N 21/23109; H04N 21/25841
USPC 725/115

(57) ABSTRACT

Method for managing interactive multimedia content designed to be displayed on the screen of a television set (30), this method comprising the following steps—Identification of at least one interactive element contained in the interactive multimedia content (10);—Labelling of a copy of the identified interactive element;—Storage of the labelled interactive element;—Provision of the stored interactive element to at least one television viewer.

This invention pertains to enriched interactive media.

Hereinafter, “television set” shall mean any receiver able to reproduce at least the visual elements of multimedia content transmitted or broadcast by a transmitter.

Furthermore, hereinafter “television” shall mean any method/system through which a broadcast channel creates multimedia content designed to be received and displayed by a television set. In particular, interactive television is television able to broadcast interactive multimedia content. Interactive multimedia content includes interactive services allowing the television viewer to introduce a personal reaction and/or to influence what he or she sees, hears, or receives.

In addition to audio/video content, interactive multimedia content includes interactive elements. These interactive elements are additional information that enriches the audio/video content of the habitual television flow for various reasons, for example, economic reasons (information about product/service offerings: Internet site addresses, emails, or telephone numbers for example), or informative reasons (comments/questions/responses associated with a given program being broadcast, news, photos, results from a given event, or the names of players on a Football team, for example).

The video content and interactive elements are typically displayed simultaneously. Therefore, the images from the video content are not the only information on the screen of the television set.

The result is that, in some cases, part of the video content being played is hidden by the interactive elements.

However, the superimposed display of the interactive elements and video images requires excessive mobilisation of the television viewer's attention in order to comprehend both pieces of information (i.e. the video images and the interactive elements) while successfully and rapidly reading the screen of the television set. Tasks requiring a high cognitive load (memorising a telephone number, a web address, or the terms of a sales offer for example) are not always suitable for television usage, which is generally associated with relaxation.

In other cases, part of the screen of the television set may be allocated solely for displaying the interactive elements (i.e. dividing the screen of the television set into two or more parts in which one part displays the interactive elements related to video content being played in another part of the screen).

Nevertheless, dividing the screen of the television set into more than one window reduces the dimensions of these windows. The result is that the information displayed (i.e. the video images and the interactive elements) will be of smaller size, and therefore less visible than if they were displayed on the full screen.

The known methods for managing interactive multimedia content broadcast on television are imperfect, in particular for the following reasons:
Being linked to the video content of a given program being broadcast, interactive elements are no longer available to the television viewer after the broadcast of the program is over, or after any channel change (zapping);
As they are being broadcast, the interactive elements are displayed for the same period for all television viewers regardless of their abilities (reading/comprehension/vision speed, and combined comprehension of the content of the various interactive media components: audio/video/interactive elements). At the same time, producers of interactive media content, especially multimedia advertising content, typically have very limited time, while seeking maximum effectiveness of the broadcast content.

One object of the present invention is to remedy the aforementioned drawbacks.

Another object of the present invention is to improve the utility of interactive multimedia content for the television viewer.

Another object of the present invention is to improve the yield from advertising investments in television.

Another object of the present invention is to facilitate the usage, and promote comfort and perception of the interactive elements in enriched media content.

Another object of the present invention is to allow collective consumption of the interactive elements in multimedia content via social networks.

To that end, the invention pertains, according to a first aspect, to a method for managing interactive multimedia content designed to be displayed on the screen of a television set, this method comprising the following steps
Identification of at least one interactive element contained in the interactive multimedia content;
Labelling of a copy of the identified interactive element;
Storage of the labelled interactive element;
Provision of the stored interactive element to at least one television viewer.

Additionally, this method includes a step for accessing the available interactive element from a user terminal.

Advantageously, the labelling step should be carried out automatically using at least one piece of information recovered from the electronic program guide associated with the interactive multimedia content.

The invention pertains, according to a second aspect, to a system for managing interactive multimedia content designed to be displayed on the screen of a television set, this system comprising
A selection module designed to identify at least one interactive element contained in the interactive multimedia content;
A labelling module designed to label a copy of the identified interactive element;
A database to store the labelled interactive element;
An interface allowing access to the content in the database.

This system also comprises a user terminal, equipped with a software application, allowing access to the content in the database.

According to a third aspect, the invention proposes a computer program product implemented on a memory medium, which may be implemented within an information processing unit, and which comprises instructions for implementing the method summarized above.

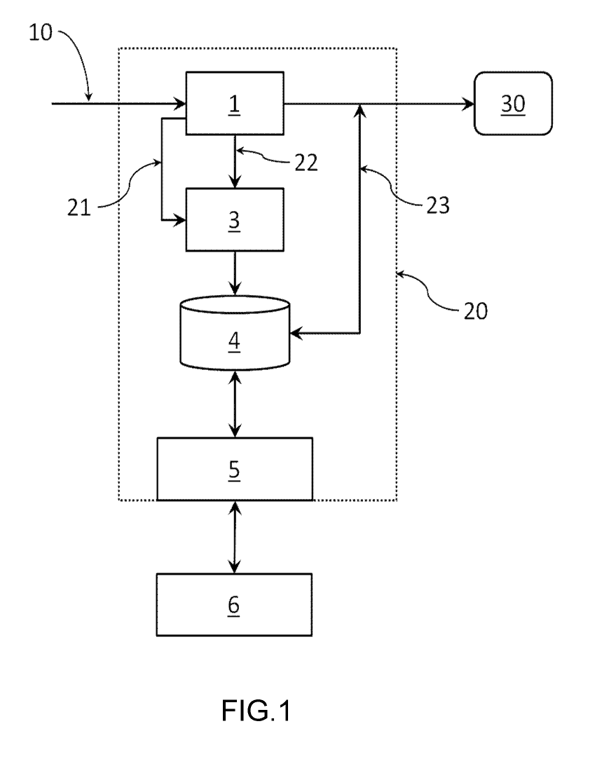

Other characteristics and advantages of the invention will become clearer more specifically after reading the following description of preferred embodiments, with reference to FIG. 1 that diagrammatically illustrates a functional representation of one embodiment.

FIG. 1 shows an adapter 20 (also called a decoder, digital receiver, or STB for Set-top Box) for real-time reception of interactive multimedia content 10 to be displayed on the screen of television set 30.

The adapter 20 is any resource able to transform an incoming signal into content that can be displayed on the screen of the television set 30.

The interactive multimedia content 10 comprises interactive elements. The interactive multimedia content flow 10 may come in real time from an Ethernet cable (IPTV for example), a satellite or VHF/UHF antenna, a telephone line, a fibre optic line, or more generally any means of local/remote digital content transmission.

The interactive multimedia content flow 10 corresponds to a program from a television channel. This flow comprises the electronic program guide (or EPG). The EPG contains information about the program being broadcast.

The selection module 1 identifies, and then sends the interactive elements, or preferably a copy of the interactive elements, from the interactive multimedia content 10 to the labelling module 3 (link 22 on FIG. 1).

In one embodiment, the selection module 1 also sends the labelling module 3 (link 21 on FIG. 1) information about the interactive multimedia content 10 being broadcast. As non-limiting examples, the information recovered from the EPG may comprise the name of the channel, the name of the program being broadcast, key words related to the program being broadcast, or the time.

The labelling module 3 adds tags (also called labels, or marks) to the interactive elements sent to it from the selection module 1. The result is that the labelling is carried out automatically.

The labelling module 3 uses the information sent to it (link 21 on FIG. 1) by the selection module 1 to label the interactive elements, which are also sent to it (link 22 on FIG. 1) by the selection module 1.

Alternatively or in combination, the television viewer may, at his or her initiative, add tags to the labelling module 3 to label the interactive elements that are sent to it from the selection module 1. In one embodiment, the television viewer may have an extensible set of tags (bookmarks) to tag (label) the interactive elements.

The interactive elements may be already labelled by the transmitter of the interactive multimedia content 10. The transmitter of the interactive multimedia content 10 may also provide labels, for example “advertisement”, “brand=Peugeot®”, “producer's name=Woody Allen”, or “title=score”. In particular, a label may be a key word, a category of interactive elements (advertisement, news, or question/answer, for example), or a brand name, thus allowing a columnar display, search, or sorting of the interactive elements.

In one embodiment, the labelling module 3 recovers labels from a remote labelling source that is indicated for it by default, or by the television viewer. An internet/intranet site or a database outside of the system are examples of label sources. As a non limiting example, a television viewer who wants to see the interactive elements in his or her own language from a given television program being broadcast in a foreign language, may specify the address of an internet site for the program being broadcast (a web site providing a TV guide for example) in a system configuration step.

Once labelled, the interactive elements are stored in a database 4, in a memory cache, or in any other means able to memorise the tagged interactive elements at least temporarily.

Alternatively or in combination, a copy of at least part (a video and/or audio sequence) of the audio and/or video content from the interactive multimedia content 10 is stored with the corresponding interactive elements in the database 4 (link 23 on FIG. 1). In particular this allows the entire stored interactive multimedia content to be redisplayed (advertising multimedia content containing interactive elements listing the details of an offer and addresses, a video sequence containing interactive elements listing the players at the start of a football match, a video sequence of a goal from a football match containing interactive elements listing the score, the time, and the name of the player who scored the goal, or a video sequence answering a question listed in the interactive elements, for example).

The labelled interactive elements may be stored by name, by program, by channel, or by key word for example.

In one embodiment, the interactive elements are shown as tag clouds by key word (advertisement, sport, questions/answers, offers, or addresses for example).

Preferably, the database 4 contains a profile of preferences to be completed when starting to view the interactive elements, which automatically adapts to the user's preferences (dynamic updating in relation to previous choices). This profile is designed to adapt the display (sorting by tag, tag cloud, or list for example) and to manage the content (access permissions for example) from the database 4 to the preferences of the television viewer.

An interface 5 allows access to and searching of the labelled interactive elements stored in the database 4.

The interface 5 is equipped with criteria for filtering the interactive content and a means of displaying the results of searches of the stored interactive elements (in the form of tag clouds or as a list for example).

The interface 5 is equipped with a means of exploring (a search engine, or a navigation tool with several graphical interfaces for example) the database 4 able to rapidly find an interactive element using its tags.

The interface 5 also allows remote access to the content in the database 4 through a user terminal 6. To do this, the interface 5 is equipped with a connection interface. This connection interface may be a wireless (Bluetooth™, HiperLAN, Wireless LAN, Home RF, WiFi and ZigBee, GSM, GPRS, W-CDMA, or WiMAX for example) or wired connection (Ethernet for example).

Advantageously, the interface 5 allows collective and individual access/usage to/of the content in the database 4 (i.e. in the case of simultaneous usage by several television viewers of the interactive content stored in the database 4, each viewer may view the content he or she wishes without disrupting the others viewers).

In particular, the user terminal 6 may be a mobile user terminal (a Smartphone, portable computer, Laptop, or PDA (Personal Digital Assistant) for example) or a fixed one (desktop computer for example). In this way, the television viewer may use his or her mobile terminal to explore and watch all of the interactive elements stored in the database 4.

In one embodiment, a software application has been developed for the user terminal 6 (in particular for Smartphones and portable computers) allowing the television viewer to access/modify the content in the database 4. Using a graphical interface from the software application, the television viewer may, for example, search, display, modify, delete, or watch an interactive element stored in the database 4.

Preferably, the software application installed on the user terminal 6 uses/coordinates with other services/resources (email, geolocation, Web navigation, communication for example) offered by the user terminal 6. As non-limiting examples, this application allows
Calling a contact using a telephone number contained in an interactive element;
Sending an email using an email address contained in an interactive element;
Locating an address or finding directions to an address contained in an interactive element;
Visiting a Web site whose address is contained in an interactive element.

Preferably, the software application installed on the user terminal 6 to access the content in the database 4 comprises an interface for communicating with social networks (Facebook, MySpace, Twitter, or Google Buzz for example) and multimedia content sharing platforms (YouTube, DailyMotion for example) allowing the television viewer to be offered interactive content that his or her friends like or to suggest some to them from the database 4.

It should be noted that the interactive elements stored in the database 4 may be displayed on the screen of a television set 30 (link 23 on FIG. 1) or of the user terminal 6 if the terminal has one.

As a non-limiting example of the application of the method described above, a television viewer who has already watched multimedia advertising content on television does not remember the addresses of the points of sale for a product, these addresses having been listed in an interactive element in the content. In this case, the television viewer
Launches the software application on his or her Smartphone 6 to remotely access his or her adapter (STB) 20,
Searches the database 4 for the interactive element (by using the name of the television channel that broadcast the content, the date he or she watched the content, or the subject of the content for example);
Extracts the addresses of the points of sale contained in the interactive element;
Requests directions to each of the points of sale selected in relation to his or her current geographic position (using a means of geolocation provided by the Smartphone 6).

Most adapters (STB) 20 allow embedded functionalities such as storing multimedia content, or have operating systems able to manage the multimedia content stored on them as well as to control the television set 30. Consequently, advantageously, implementing the method described above does not require significant modification of existing adapters.

The method and system just described exhibit a certain number of advantages. In particular, they make it possible to:
Improve the yield of multimedia advertising content: freedom from the time slot (the television viewer can watch the multimedia advertising content or at least its interactive elements at a time that is convenient to him or her). The fact of making the details of a sales offer (shop address, discount rate, Web site address, advantages of the offer for example) available at any time promotes a higher yield;
Change (zap) from one channel to another while watching the interactive elements from multimedia content that was broadcast (or is being broadcast if the adapter 20 is a bi-tuner) on another channel;
Re-watch interactive multimedia content when one realizes its importance after the fact or when one was busy at the time it was broadcast;
Watch, if the adapter 10 is a “double tuner”

It should be noted here that the terms “module” and “interface” cover any means incorporating a processor programmed to carry out one or more predetermined functions, or any software application (program or sub-program, plugin) implemented on a processor, independent from or in combination with other software applications.

1. Method for managing interactive multimedia content designed to be displayed on the screen of a television set, this method comprising:
Identification of at least one interactive element contained in the interactive multimedia content;
Labelling of a copy of the identified interactive element;
Storage of the labelled interactive element;
Provision of the stored interactive element to at least one television viewer.

2. Method according to claim 1, wherein it also comprises accessing the available interactive element from a user terminal.

3. Method according to claim 2, wherein it also comprises using at least one service offered by the user terminal.

4. Method according to claim 3, wherein the service used is a geolocation service able to find directions to an address contained in the interactive element.

5. Method according to claim 1, wherein the labelling uses at least one piece of information recovered from the electronic program guide associated with the interactive multimedia content.

6. Method according to claim 1, wherein the labelling uses at least one piece of information provided by the television viewer.

7. Method according to claim 1, wherein the labelling uses at least one piece of information recovered from a remote label source.

8. Method according to claim 1, wherein a copy of part of the interactive multimedia content is stored in association with the labelled interactive element.

9. System for managing interactive multimedia content designed to be displayed on the screen of a television set, this method comprising:
A selection module designed to identify at least one interactive element contained in the interactive multimedia content;
A labelling module designed to label a copy of the identified interactive element;
A database to store the labelled interactive element;
An interface allowing access to the content in the database.

10. System according to claim 9, wherein the labelling module uses at least one piece of information recovered from the electronic program guide associated with the interactive multimedia content.

11. System according to claim 9, wherein the selection module, the labelling module, the database, and the interface are contained in an adapter associated with the television set.

12. System according to claim 9, wherein it also comprises a user terminal allowing access to the content in the database.

13. System according to claim 12, wherein the user terminal is equipped with a software application allowing access to the content in the database.

14. System according to claim 13, wherein the software application uses at least one service offered by the user terminal.

15. A computer program product implemented on a memory medium, which may be implemented within a computer processing unit, and which comprises instructions to implement the method according to claim 1.
